(19) United States
(12) Patent Application Publication
(10) Pub. No.: US 2026/0285372 A1
(43) Pub. Date: Sep. 24, 2026

(54) SYSTEMS AND METHODS FOR GENERATING LANE-BASED TRAFFIC DENSITY MAPS FOR AUTONOMOUS VEHICLES

(71) Applicant: Torc Robotics, Inc., Blacksburg, VA (US)

(72) Inventors: Maximilian Yassine Beyen, Leutenbach (DE); David Unger, Stuttgart (DE); Juncong Fei, Stuttgart (DE)

(21) Appl. No.: 19/082,961

(22) Filed: Mar. 18, 2025

(51) Int. Cl. B60W 60/00; B60W 30/18; G06T 7/73; G06V 20/58; G08G 1/01; G08G 1/16

(52) U.S. Cl. CPC B60W 60/0027; B60W 30/18163; G06T 7/73; G06V 20/58; G08G 1/0133; G08G 1/167; B60W 2552/10; B60W 2554/4045; B60W 2554/406; B60W 2556/40; B60W 2556/45; G06T 2207/30236; G06T 2207/30252; G06V 2201/08

(57) ABSTRACT

An autonomy computing system of an autonomous vehicle for generating a traffic density map is provided. At least one processor of the system is programmed to: receive sensor data from an autonomous vehicle of a road along which the autonomous vehicle is traveling, extract one or more objects on the road based on the sensor data, the one or more objects being represented in pixel coordinates, transform the pixel coordinates to world coordinates, generate a traffic map of the road by assigning the one or more objects to corresponding lanes based on the world coordinates, calculate traffic density per lane of the road based on the objects in the traffic map, and output a traffic density map based on the traffic density, the traffic density map including the traffic map marked with the traffic density per lane.

### TECHNICAL FIELD

The field of the disclosure relates generally to autonomous vehicles and, more specifically, to systems and methods for generating traffic density maps for autonomous vehicles.

### BACKGROUND OF THE INVENTION

An autonomous vehicle relies on an autonomy computing system to perceive the environment in which the autonomous vehicle operates, control operation of the autonomous vehicle, and/or perform the operation of the autonomous vehicle. To assist in routing, autonomous vehicles use map data to plan routes, determine trajectories, and adjust the behavior of the autonomous vehicle. Traffic data may be used to supplement the decision-making of autonomous vehicles. However, traffic density data is difficult to collect accurately. Accordingly, it is desirable to have improved systems and methods for generating lane-based traffic density maps for autonomous vehicles.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomy computing system of an autonomous vehicle for generating a traffic density map is provided. The autonomy computing system comprising at least one processor in communication with at least one memory device, the at least one processor being programmed to receive sensor data from a first autonomous vehicle of a road along which the first autonomous vehicle is traveling, extract one or more objects on the road based on the sensor data, the one or more objects being represented in pixel coordinates, transform the pixel coordinates to world coordinates, generate a traffic map of the road by assigning the one or more objects to corresponding lanes based on the world coordinates. The processor is further programmed to calculate traffic density per lane of the road based on the objects in the traffic map, and output a traffic density map based on the traffic density, the traffic density map including the traffic map marked with the traffic density per lane.

In yet another aspect, a method for generating a traffic density map is provided. The method includes receiving sensor data from an autonomous vehicle of a road along which the autonomous vehicle is traveling, extracting one or more objects on the road based on the sensor data, the one or more objects being represented in pixel coordinates, transforming the pixel coordinates to world coordinates, and generating a traffic map of the road by assigning the one or more objects to corresponding lanes based on the world coordinates. The method further includes calculating traffic density per lane of the road based on the objects in the traffic map, outputting a traffic density map based on the traffic density, the traffic density map including the traffic map marked with the traffic density per lane.

In yet another aspect, at least one non-transitory computer-readable storage medium for generating a traffic density map is provided. The at least one non-transitory computer-readable storage medium includes a plurality of instructions stored thereon that, in response to being executed, cause a system to: receive sensor data from an autonomous vehicle of a road along which the autonomous vehicle is traveling, extract one or more objects on the road based on the sensor data, the one or more objects being represented in pixel coordinates. The instructions further cause the system to transform the pixel coordinates to world coordinates, generate a traffic map of the road by assigning the one or more objects to corresponding lanes based on the world coordinates, calculate traffic density per lane of the road based on the objects in the traffic map, and output a traffic density map based on the traffic density, the traffic density map including the traffic map marked with the traffic density per lane.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 is a flowchart of an example method for generating a traffic density map;

FIG. 4 shows an example transformation between an object detection in pixel coordinates and a traffic map in world coordinates;

FIG. 5 shows an example traffic density map;

FIG. 6A is a schematic diagram of an example neural network model;

FIG. 6B is a schematic diagram of a neuron in the example neural network model shown in FIG. 6A;

FIG. 7 is a block diagram of an example computing device; and

FIG. 8 is a block diagram of an example server computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems and methods for generating a lane-based traffic density map are provided. An autonomy computing system of an autonomous vehicle detects features in the environment in which the autonomous vehicle operates, generates control policies based on the features, and executes the control policies to control operation of the autonomous vehicle. The autonomy computing system uses a traffic map and/or traffic density map to update behaviors and routes of the autonomous vehicle to assist the autonomous vehicle in navigation.

In generating a traffic density map, precise locational data that is updated in real-time and not restricted a static area is needed to control the behavior of autonomous vehicles. At least some known methods of determining traffic density are error prone and/or limited to fixed locations, leading to routing issues for vehicles relying on the data. Furthermore, traffic density is not provided at a lane-level, which prevents autonomous vehicles relying on the data from making informed decisions regarding future trajectories, behaviors, routes, and/or lane changes. At least some known systems and methods use, for example, Global Positioning System (GPS) locational data of mobile devices having cellular connections to determine traffic density in an area. These existing systems provide only an estimate of traffic density for an area, and do not generate per-lane traffic densities. For example, these systems are error-prone due to the nature of the data collection, such as introducing errors related to having multiple devices in one vehicle or no device in a vehicle. While traffic cameras provide more precise data compared to GPS data, they are costly and restricted to monitoring static areas, thus being prohibitively costly to use to monitor entire road systems. These existing systems and methods are not capable of providing accurate per-lane traffic density readings in real-time to autonomous vehicles.

In contrast, systems and methods described herein generate precise lane-based traffic density maps in real-time based on objects detected by perception systems of autonomous vehicles. An autonomous vehicle extracts one or more objects on the road based on the sensor data. The position of the autonomous vehicle may be determined. Based on the pixel coordinates of the objects in the sensor data and the position of the autonomous vehicle, pixel coordinates of the objects may be transformed to world coordinates. This allows precision location information to be obtained for objects within sensing distance of the autonomous vehicle, including a determination of the lane the objects are located in. The detected objects are assigned to a corresponding lane in a world map based on the world coordinates to generate a traffic map. The system then determines a traffic density for each lane in the traffic map and outputs a traffic density map based on the traffic density in each lane. The traffic density map is used by the autonomous vehicle to determine a trajectory change. In some embodiments, the traffic density map from a plurality of autonomous vehicles may be transmitted to a server computing device to generate a comprehensive traffic density map. The comprehensive traffic density map may be transmitted to individual autonomous vehicles to improve trajectory planning.

The lane-based traffic density information from the traffic density map is used to update the behaviors and/or routes of one or more vehicles, such as by updating a vehicle’s trajectory to reduce a risk of accident or improve route efficiency by avoiding congested lanes or lanes which are predicted to have a large amount of merge-in or merge-out lane changes by other vehicles. The systems and methods described herein are advantageous for traffic density map generation as having increased precision in determining individual lanes of detected objects when determining traffic density, avoiding errors of false positives in traffic detection, and are not tied to a static location to monitor traffic density. The systems and methods described herein are advantageous to improve the operation of vehicles and autonomous vehicles by allowing safe and efficient routes to be calculated in real-time based on per-lane traffic density data.

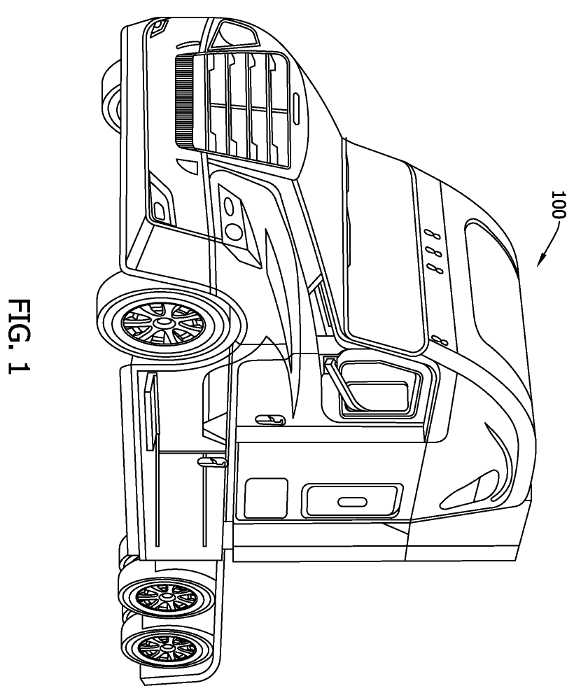

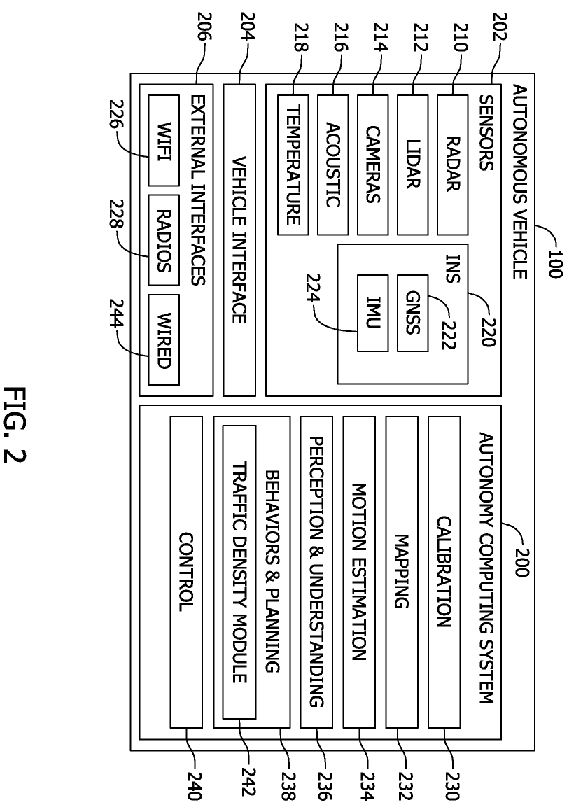

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operation of autonomous vehicle 100.

Cameras 214 are configured to capture images of the environment surrounding autonomous vehicle 100 in any aspect or field of view (FOV). The FOV can have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras’ FOVs, which may be used to, for example, generate a bird’s eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 can be captured and represented in the LiDAR point clouds. Radar sensors 210 may include short-range radar (SRR), mid-range radar (MRR), long-range radar (LRR), or ground-penetrating radar (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and traffic density module 242. Traffic density module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Traffic density module 242 receives sensor data from one or more sensors. Traffic density module 242 extracts one or more objects on the road based on the sensor data, the one or more objects being represented in pixel coordinates in an object list. Traffic density module 242 transforms the pixel coordinates to world coordinates and generates a traffic map of the road by assigning the one or more objects to corresponding lanes in the traffic map based on the world coordinates. Traffic density module 242 calculates a traffic density per lane of the road based on the objects in the traffic map, and outputs a traffic density map based on the traffic density. The traffic density map may include the traffic map marked with the traffic density per lane.

Autonomy computing system 200 of autonomous vehicle 100 may be completely autonomous (fully autonomous), semi-autonomous, or with any level of autonomy. In one example, autonomy computing system 200 can operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein the term “autonomous” includes fully autonomous, semi-autonomous, or having any level of autonomy.

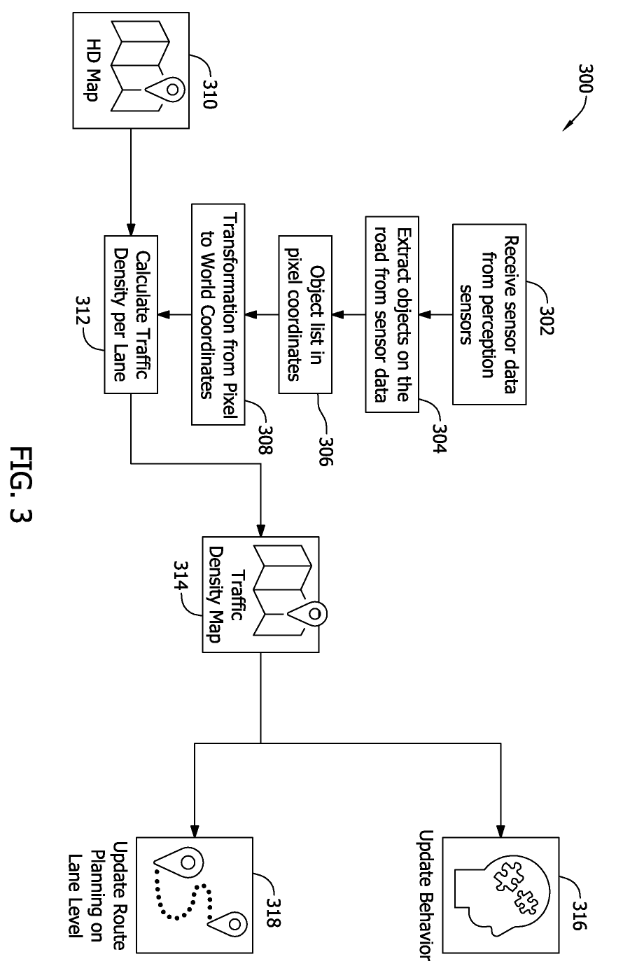

FIG. 3 shows an example method 300 for generating a traffic density map. Method 300 may be implemented in traffic density module 242. In the example embodiment, autonomy computing system 200 receives 302 sensor data from one or more perception sensors. One or more objects are extracted 304 to generate 306 an object list of objects on the road based on the sensor data, the objects being represented in pixel coordinates. In one example, one or more objects are extracted 304, via a perception machine learning model. Pixel coordinates of objects are transformed 308 to world coordinates. Objects are assigned to corresponding lanes of the road based on world coordinates to generate a traffic map. The traffic map is generated based on a map 310, such as a map of the area including lane lines or other lane delimiters. A traffic density is calculated 312 per lane of the road based on objects in the traffic map. A traffic density map 314 is output based on the traffic density and traffic map with traffic density marked per lane. Traffic density map 314 is used to update 316 behavior and/or update 318 route planning of an autonomous vehicle.

In the example embodiment, method 300 includes receiving 302 data from one or more perception sensors. Perception sensors 202 (see FIG. 2) include, for example, vision sensors, LiDAR sensors, radar sensors, and/or sonar sensors. Vision sensors include sensors producing data in image formats, for example, cameras. Sensor data is received in a variety of formats, including both 2D and 3D, such as images and/or point clouds, respectively.

In the example embodiment, method 300 extracts 304 one or more objects on the road based on the sensor data via a perception machine learning model. Objects include actors and/or the road. Extracting 304 includes, for example, machine-learning based object detection or other feature detection and/or extraction methods. In some embodiments, objects are extracted via an analytical method, such as analytical image segmentation methods.

In the example embodiment, the objects are represented in pixel coordinates corresponding to their pixel location in the sensor data. For example, in a received camera image of 1000x1000 pixels, the top left pixel could be at position (0,0), while the bottom right pixel could be at position (1000, 1000). In some embodiments, objects detected may be supplemented with additional feature data that is extracted 304 by perception machine learning model, such as depth information including a depth map, bounding boxes around the objects, positional information, and/or other data pertaining to properties of the objects. In some embodiments, objects are detected based on a value calculated or a determination made from the extracted objects and/or sensor data, such as optical flow.

In the example embodiment, method 300 includes transforming 308 pixel coordinates of objects to world coordinates and to associate the objects with a position on map 310 based on the world coordinates. World coordinates include coordinates corresponding to map 310. Example world coordinates include longitude/latitude coordinates, World Geodetic System (WGS84), East-North-up (ENU) coordinates, or other positional coordinates and/or positional markers corresponding to a geographic location on map 310. Transformation of pixel coordinates to world coordinates uses a location of autonomous ego vehicle 100 and/or pose of ego vehicle 100 associated with the perception sensor data. Because the position of the sensors on the ego vehicle is known or may be determined, the pixel coordinates are transformed 308 using the location of the ego vehicle combined with the pixel coordinates of objects in sensor data and other relevant information, such as depth information of the objects, to transform the pixel coordinates to world coordinates. For example, pixel coordinates may be transformed into world coordinates based on a position of the vehicle and a depth map produced from the sensor data, where the depth map is used in conjunction with the vehicle position to determine how far each pixel coordinate is from the vehicle, resulting in a world coordinate location for each pixel coordinate. Using the vehicle’s position and information produced from sensor data allows the vehicle to update traffic density information in real-time as the vehicle travels through and perceives the environment using data local to the vehicle, reducing computational overhead and time-lag associated with transmission of data to remote servers. As used herein, a process being real-time refers to the process not having a noticeable lag. In some embodiments, updating the traffic density information in real-time may include updating the information in the time between receipt of a first frame and a second frame of sensor data. In some embodiments, map 310 is an existing digital map that is not generated by ego vehicle 100 and includes lane information, such as an HD map. By using existing digital map 310 with lane information included, the autonomous vehicle improves the consistency of pathfinding by removing the risk of missing map information such as the number of lanes, road shape, or other static road features due to occlusions of the perception system.

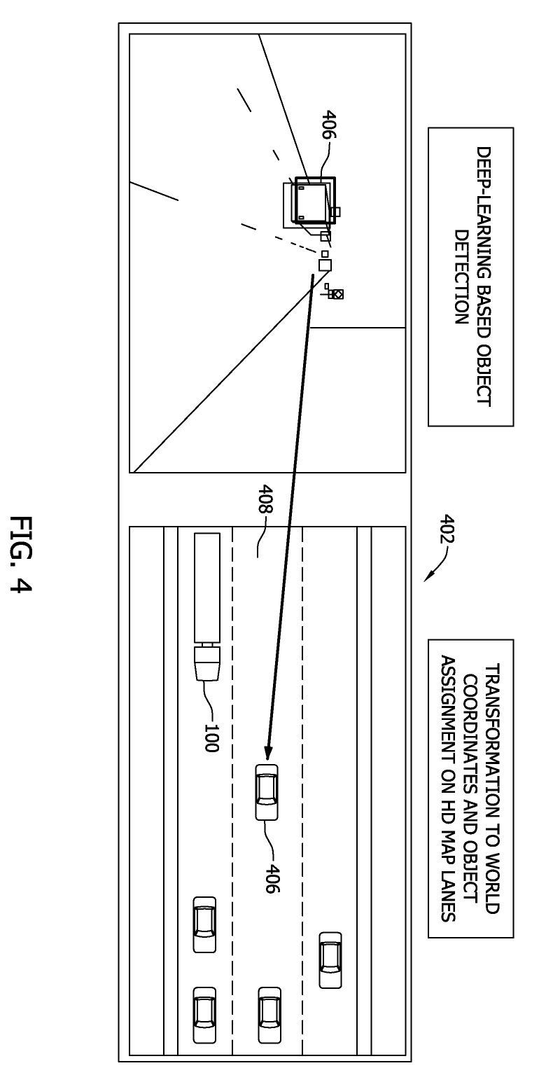

In the example embodiment, method 300 includes generating a traffic map 402 of the road by assigning objects to corresponding lanes of the road based on the world coordinates. FIG. 4 shows an example of the process of generating traffic map 402 by assigning an object detection in pixel coordinates to traffic map 402 in world coordinates. Ego vehicle 100 detects objects based on sensor data, shown by the bounding boxes in FIG. 4. Objects are converted from pixel coordinates to world coordinates and assigned to a corresponding lane in map 310 of the same scene detected by the perception system of ego vehicle 100. For example, a vehicle 406 is detected as being in a middle lane 408 to the front left of ego vehicle 100 based on the world coordinates of vehicle 406 and positions of ego vehicle 100, and vehicle 406 is assigned to the corresponding lane and position in traffic map 402. A map and/or lane positions may be used in assigning corresponding lanes for vehicle 406. This process is repeated for detected objects to fill traffic map 402 with the lane locations of detected objects.

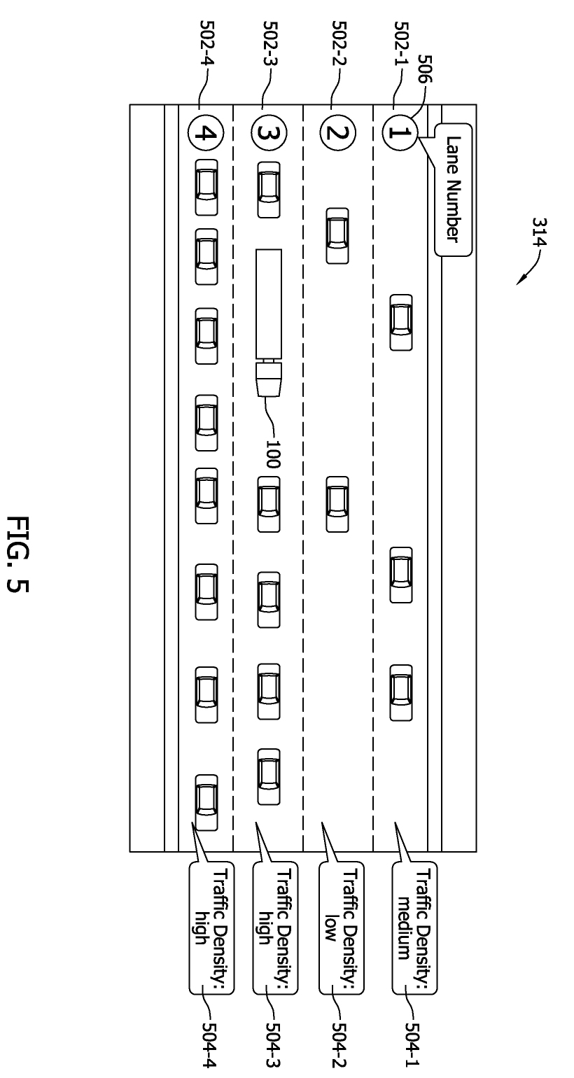

In the example embodiment, method 300 includes calculating 312 traffic density per lane of the road based on objects in traffic map 402 to output traffic density map 314. For example, as shown in FIG. 5, a first lane 502-1 with three vehicles is assigned a “medium” density 504-1, a second lane 502-2 with one vehicle is assigned a “low” density 504-2, a third lane 502-3 with six vehicles including an ego vehicle 100 is assigned a “high” density 504-3, and a fourth lane 502-4 with seven vehicles is assigned a “high” density 504-4. Densities are displayed as non-numerical values (e.g., empty, low, medium, high) as example for illustration purposes only. Densities may be represented in other formats, such as numerical values (e.g., a number directly representing the number of vehicles in the area or based on other calculation methods). After traffic densities are assigned for lanes in traffic map 402, method 300 includes outputting traffic density map 314, including traffic map 402 marked with the traffic density per lane. In some embodiments, each lane of traffic density map 314 is marked with a corresponding lane number 506.

In the example embodiment, method 300 includes updating 316 one or more behaviors of the autonomous vehicle using traffic density map 314. Updating 316 behaviors includes altering trajectories and/or changing driving rules for the autonomous vehicle. For example, updating 316 includes instructing the vehicle to make one or more trajectory changes based on information in traffic density map 314, such as lane changes or velocity changes based on lane density values. In the example shown in FIG. 5, method 300 may instruct ego vehicle 100 to move from third lane 502-3 to second lane 502-2 to minimize the traffic density value of the lane in which ego vehicle 100 is travelling. In some embodiments, method 300 uses density values to predict behavior changes by other objects and/or vehicles and instruct ego vehicle 100 to change behavior based on predicted behavior changes by the other objects and/or vehicles. For example, method 300 may predict that vehicles in third lane 502-3 and fourth lane 502-4 will change lanes by shifting left based on the “high” density values associated with those lanes and the “low” density value associated with second lane 502-2. As a result, method 300 updates 316 the behavior of ego vehicle 100 to instead shift to first lane 502-1, as it is predicted that third lane 502-3 will increase in density and be the subject of many merge-in lane changes, resulting in more hazardous and dense conditions compared to first lane 502-1. By updating 316 behaviors of autonomous vehicles based on per-lane traffic density values and predicted actions of other actors, the behaviors of autonomous vehicles are updated in real-time as traffic density values are detected to improve the safety, comfort, and efficiency of trajectories of autonomous vehicles, such as by avoiding harsh braking, sudden lane changes, or risks posed by other vehicles when approaching a traffic jam.

In the example embodiment, method 300 includes updating 318 one or more routes of the autonomous vehicle using traffic density map 314. For example, traffic density values are collected from multiple autonomous vehicles and used to create a compiled traffic density map. The complied traffic density map contains information from a plurality of autonomous vehicles, allowing long-distance routing information to be determined based on lane-level traffic density values. For example, a long-distance route of autonomous vehicle is updated 318 to instruct a future-lane change based on measured per-lane traffic density values on part of the route the autonomous vehicle will take in the future. For example, method 300 may instruct an autonomous vehicle to change lanes at a point three kilometers further on the route to avoid predicted congestion. Method 300 may update 318 the route either continuously or periodically based on newly received traffic density information from the ego vehicle, other vehicles, or other sources. By integrating lane-based traffic density values into route-planning, routes of autonomous vehicles may be adapted in advance to avoid areas with heavy density. Autonomous vehicles use traffic density map 314 to plan lane changes in advance of lanes with heavy density to improve the efficiency of routes by reducing the probability of encountering hazardous road congestion conditions and achieve positions in safe and/or low-density lanes before a high-density area is reached.

In some embodiments, method 300 includes transmitting and receiving traffic density map 314 to and from another autonomous vehicle. For example, if another autonomous vehicle is two kilometers behind the ego vehicle 100, the ego vehicle 100 transmits traffic density map 314 to the other autonomous vehicle to allow the other autonomous vehicle to adjust a behavior or route in advance of reaching the area. Method 300 may continuously transmit traffic density map 314 as the map is updated, or may periodically transmit traffic density map 314 based on one or more criteria, such as when an elapsed time since last transmission, a traffic density value, or another criteria meets a threshold value. For example, if a “high” traffic density value is detected, traffic density map 314 is transmitted to allow the second autonomous vehicle to update a route and/or trajectory to avoid or mitigate the impact of the high traffic area.

In some embodiments, method 300 includes transmitting traffic data and/or traffic density data to a server computing device, for example, implemented as server computing device 900 shown in FIG. 9. The server computing devices receives per lane traffic density data from a plurality of autonomous vehicles and updates traffic density map 314 based on the received traffic density data. Receiving traffic density data from a plurality of autonomous vehicles is advantageous in increasing the accuracy of traffic density map 314 of an area because different autonomous vehicles sense various portions of the environment in the area. Traffic density map 314 is transmitted from the server computing device to one or more autonomous vehicles. In some embodiments, routing and/or trajectories for the one or more autonomous vehicles are updated using traffic density module 242 based on the traffic density map 314 received from the server computing device. By centralizing traffic density map 314 using real-time updates from a plurality of autonomous vehicles, comprehensive traffic density coverage is obtained by the server computing device and transmitted to autonomous vehicles to enable improved routing and behavioral updates for multiple autonomous vehicles. For example, an autonomous vehicle may be able to observe a traffic jam observed by another autonomous vehicle through traffic density map 314 received from the server computing device and change routes or lanes accordingly to minimize risks and improve efficiency.

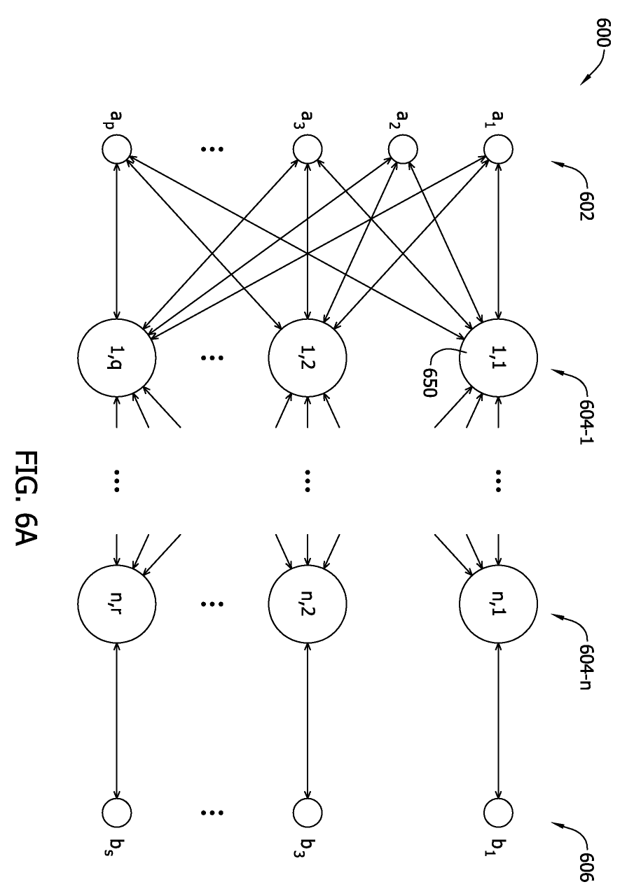

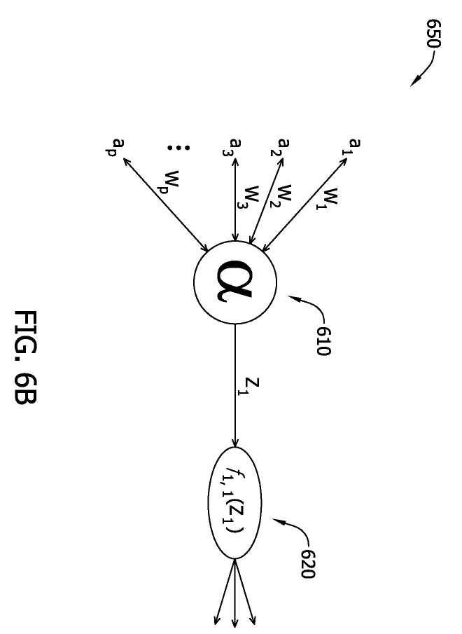

FIG. 6A depicts an example artificial neural network model 600. Traffic density module 242, and method 300 may be implemented with one or more neural networks 600. The example neural network model 600 includes layers of neurons 650, 604-1 to 604-n, and 606, including an input layer 602, one or more hidden layers 604-1 through 604-n, and an output layer 606. Each layer may include any number of neurons, i.e., q, r, and n in FIG. 6A may be any positive integer. It should be understood that neural networks of a different structure and configuration from that depicted in FIG. 6A may be used to achieve the methods and systems described herein.

In the example embodiment, the input layer 602 may receive different input data. For example, the input layer 602 includes a first input a₁representing training images, a second input a₂ representing patterns identified in the training images, a third input a₃ representing edges of the training images, and so on. The input layer 602 may include thousands or more inputs. In some embodiments, the number of elements used by the neural network model 600 changes during the training process, and some neurons are bypassed or ignored if, for example, during execution of the neural network, they are determined to be of less relevance.

In the example embodiment, each neuron in hidden layer(s) 604-1 through 604-n processes one or more inputs from the input layer 602, and/or one or more outputs from neurons in one of the previous hidden layers, to generate a decision or output. The output layer 606 includes one or more outputs each indicating a label, confidence factor, weight describing the inputs, and/or an output image. In some embodiments, however, outputs of the neural network model 600 are obtained from a hidden layer 604-1 through 604-n in addition to, or in place of, output(s) from the output layer(s) 606.

In some embodiments, each layer has a discrete, recognizable function with respect to input data. For example, if n is equal to 3, a first layer analyzes the first dimension of the inputs, a second layer analyzes the second dimension, and the final layer analyzes the third dimension of the inputs. Dimensions may correspond to aspects considered strongly determinative, then those considered of intermediate importance, and finally those of less relevance.

In other embodiments, the layers are not clearly delineated in terms of the functionality they perform. For example, two or more of hidden layers 604-1 through 604-n may share decisions relating to labeling, with no single layer making an independent decision as to labeling.

FIG. 6B depicts an example neuron 650 that corresponds to the neuron labeled as “1,1” in hidden layer 604-1 of FIG. 6A, according to one embodiment. Each of the inputs to the neuron 650 (e.g., the inputs in the input layer 602 in FIG. 6A) is weighted such that input a₁ through aₚcorresponds to weights w₁through wₚ as determined during the training process of the neural network model 600.

In some embodiments, some inputs lack an explicit weight, or have a weight below a threshold. The weights are applied to a function α (labeled by a reference numeral 610), which may be a summation and may produce a value z₁ which is input to a function 620, labeled as f _{1,1}(z₁). The function 620 is any suitable linear or non-linear function. As depicted in FIG. 6B, the function 620 produces multiple outputs, which may be provided to neuron(s) of a subsequent layer, or used as an output of the neural network model 600. For example, the outputs may correspond to index values of a list of labels, or may be calculated values used as inputs to subsequent functions.

It should be appreciated that the structure and function of the neural network model 600 and the neuron 650 depicted are for illustration purposes only, and that other suitable configurations exist. For example, the output of any given neuron may depend not only on values determined by past neurons, but also on future neurons.

The neural network model 600 may include a convolutional neural network (CNN), a deep learning neural network, a reinforced or reinforcement learning module or program, or a combined learning module or program that learns in two or more fields or areas of interest. Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. The neural network model 600 may be trained using unsupervised machine learning programs. In unsupervised machine learning, the processing element may be required to find its own structure in unlabeled example inputs. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics, and information. The machine learning programs may use deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing – either individually or in combination. The machine learning programs may also include natural language processing, semantic analysis, automatic reasoning, and/or machine learning.

Based upon these analyses, the neural network model 600 may learn how to identify characteristics and patterns that may then be applied to analyzing image data, model data, and/or other data. For example, the model 600 may learn to identify features in a series of data points.

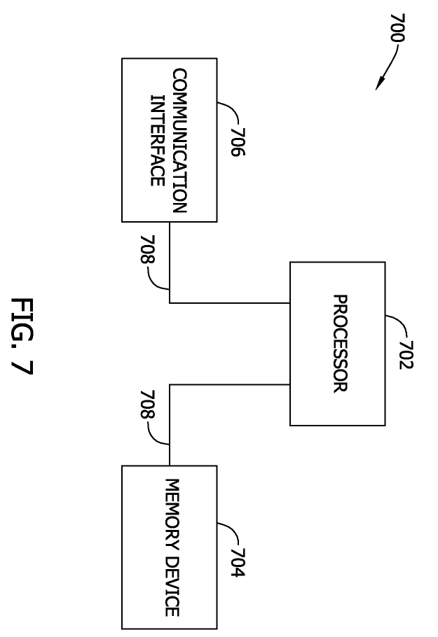

FIG. 7 is a block diagram of an example computing device 700. Autonomy computing system 200 and traffic density module 242 may be implemented with one or more computing devices 700. Computing device 700 includes a processor 702 and a memory device 704. The processor 702 is coupled to the memory device 704 via a system bus 708. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 704 includes one or more devices that enable information, such as executable instructions or other data (e.g., sensor data), to be stored and retrieved. Moreover, the memory device 704 includes one or more computer readable media, such as, without limitation, dynamic random access memory (DRAM), static random access memory (SRAM), a solid state disk, or a hard disk. In the example embodiment, the memory device 704 stores, without limitation, application source code, application object code, configuration data, additional input events, application states, assertion statements, validation results, or any other type of data. The computing device 700, in the example embodiment, may also include a communication interface 706 that is coupled to the processor 702 via system bus 708. Moreover, the communication interface 706 is communicatively coupled to data acquisition devices.

In the example embodiment, processor 702 may be programmed by encoding an operation using one or more executable instructions and providing the executable instructions in the memory device 704. In the example embodiment, the processor 702 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

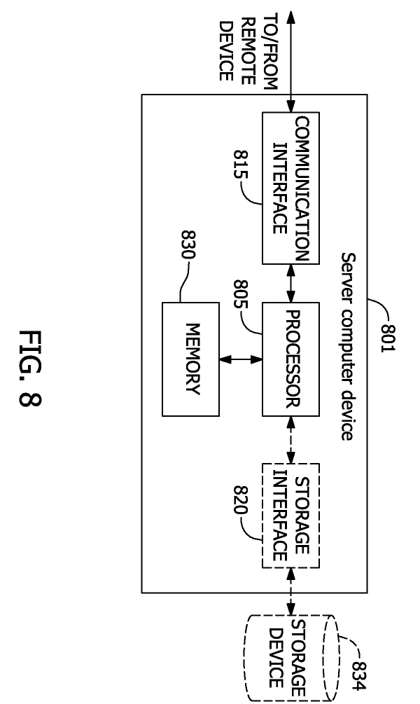

FIG. 8 illustrates an example configuration of a server computer device 801. Systems and methods described herein may be implemented with one or more server computer devices 801. In the example embodiment, server computer device 801 also includes a processor 808 for executing instructions. Instructions may be stored in a memory area 830, for example. Processor 808 may include one or more processing units (e.g., in a multicore configuration).

Processor 808 is operatively coupled to a communication interface 817 such that server computer device 801 is capable of communicating with a remote device or another server computer device 801. For example, communication interface 817 may receive data from a system such as autonomy computing system 200, via the Internet.

Processor 808 may also be operatively coupled to a storage device 834. Storage device 834 is any computer-operated hardware suitable for storing and/or retrieving data. In some embodiments, storage device 834 is integrated in server computer device 801. For example, server computer device 801 may include one or more hard disk drives as storage device 834. In other embodiments, storage device 834 is external to server computer device 801 and may be accessed by a plurality of server computer devices 801. For example, storage device 834 may include multiple storage units such as hard disks and/or solid state disks in a redundant array of independent disks (RAID) configuration. storage device 834 may include a storage area network (SAN) and/or a network attached storage (NAS) system.

In some embodiments, processor 808 is operatively coupled to storage device 834 via a storage interface 820. Storage interface 820 is any component capable of providing processor 808 with access to storage device 834. Storage interface 820 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 808 with access to storage device 834.

### MACHINE LEARNING & OTHER MATTERS

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium. A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing – either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

An example technical effect of the methods, systems, and apparatus described herein includes at least one of: (a) improving the precision of traffic density maps, (b) production of lane-based traffic density maps (c) generating lane-based traffic density maps in real-time, and (d) improving the routing of autonomous computing systems performance in traffic-dense environments.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An autonomy computing system of an autonomous vehicle for generating a traffic density map, the autonomy computing system comprising at least one processor in communication with at least one memory device, the at least one processor programmed to:
receive sensor data from an autonomous vehicle of a road along which the autonomous vehicle is traveling;
extract one or more objects on the road based on the sensor data, the one or more objects being represented in pixel coordinates;
transform the pixel coordinates to world coordinates;
generate a traffic map of the road by assigning the one or more objects to corresponding lanes based on the world coordinates;
calculate traffic density per lane of the road based on the objects in the traffic map;
output a traffic density map based on the traffic density, the traffic density map including the traffic map marked with the traffic density per lane; and
control operation of the autonomous vehicle based on the traffic density map.

2. The traffic density computing device of claim 1, the at least one processor is further programmed to:
transmit the traffic density map to a server computing device;
receive an updated traffic density map updated by the server computing device based on traffic density maps from a plurality of autonomous vehicles; and
control operation of the autonomous vehicle based on the updated traffic density map.

3. The traffic density computing device of claim 1, wherein the processor is further configured to update a trajectory of another autonomous vehicle based on the traffic density map.

4. The traffic density computing device of claim 1, wherein the processor is further configured to update a behavior of the autonomous vehicle based on the traffic density map.

5. The traffic density computing device of claim 4, wherein the processor is further configured to update the behavior of the autonomous vehicle to change lanes based on a prediction that other one or more vehicles will change lanes based on the traffic density.

6. The traffic density computing device of claim 1, wherein the processor is further configured to transform the pixel coordinates to world coordinates based on a position of the vehicle and a depth map associated with the sensor data.

7. The traffic density computing device of claim 1, wherein the processor is further configured to generate, in real-time, the traffic map of the road by assigning the one or more objects to corresponding lanes of an existing digital map based on the world coordinates.

8. At least one non-transitory computer-readable storage medium for generating a traffic density map, the at least one non-transitory computer-readable storage medium comprising a plurality of instructions stored thereon that, in response to being executed, cause a system to:
receive sensor data from an autonomous vehicle of a road along which the autonomous vehicle is traveling;
extract one or more objects on the road based on the sensor data, the one or more objects being represented in pixel coordinates;
transform the pixel coordinates to world coordinates;
generate a traffic map of the road by assigning the one or more objects to corresponding lanes based on the world coordinates;
calculate traffic density per lane of the road based on the objects in the traffic map;
output a traffic density map based on the traffic density, the traffic density map including the traffic map marked with the traffic density per lane; and
control operation of the autonomous vehicle based on the traffic density map.

9. The least one non-transitory computer-readable storage medium of claim 8, wherein the plurality of instructions further cause the system to:
transmit the traffic density map to a server computing device;
receive an updated traffic density map updated by the server computing device based on traffic density maps from a plurality of autonomous vehicles; and
control operation of the autonomous vehicle based on the updated traffic density map.

10. The least one non-transitory computer-readable storage medium of claim 8, wherein the plurality of instructions further cause the system to update a trajectory of another autonomous vehicle based on the traffic density map.

11. The least one non-transitory computer-readable storage medium of claim 8, wherein the plurality of instructions further cause the system to update a behavior of the autonomous vehicle based on the traffic density map.

12. The least one non-transitory computer-readable storage medium of claim 11, wherein the plurality of instructions further cause the system to update a behavior of the autonomous vehicle to change lanes based on a prediction that other one or more vehicles will change lanes based on the traffic density.

13. The least one non-transitory computer-readable storage medium of claim 8, wherein the plurality of instructions further cause the system to transform the pixel coordinates to world coordinates based on a position of the vehicle and a depth map associated with the sensor data.

14. The least one non-transitory computer-readable storage medium of claim 8, wherein the plurality of instructions further cause the system to generate, in real-time, the traffic map of the road by assigning the one or more objects to corresponding lanes of an existing digital map based on the world coordinates.

15. A method for generating a traffic density map, the method comprising:
receiving sensor data from an autonomous vehicle of a road along which the autonomous vehicle is traveling;
extracting one or more objects on the road based on the sensor data, the one or more objects being represented in pixel coordinates;
transforming the pixel coordinates to world coordinates;
generating a traffic map of the road by assigning the one or more objects to corresponding lanes based on the world coordinates;
calculating traffic density per lane of the road based on the objects in the traffic map; and
outputting a traffic density map based on the traffic density, the traffic density map including the traffic map marked with the traffic density per lane; and
controlling operation of the autonomous vehicle based on the traffic density map.

16. The method of claim 15, further comprising:
transmitting the traffic density map to a server computing device;
receiving an updated traffic density map updated by the server computing device based on traffic density maps from a plurality of autonomous vehicles; and
controlling operation of the autonomous vehicle based on the updated traffic density map.

17. The method of claim 15, further comprising updating a trajectory of another autonomous vehicle based on the traffic density map.

18. The method of claim 15, further comprising updating a behavior of the autonomous vehicle based on the traffic density map.

19. The method of claim 18, further comprising updating a behavior of the autonomous vehicle to change lanes based on a prediction that other one or more vehicles will change lanes based on the traffic density.

20. The method of claim 15, further comprising transforming the pixel coordinates to world coordinates based on a position of the vehicle and a depth map associated with the sensor data.
